(19) United States
(12) Patent Application Publication
(10) Pub. No.: US 2008/0187807 A1
(43) Pub. Date: Aug. 7, 2008

(54) Fuel Cells With Reduced Weight and Volume

(75) Inventors: Thomas Schmidt, Morfelden-Walldorf (DE); Oemer Uensal, Mainz (DE)

Correspondence Address: CONNOLLY BOVE LODGE & HUTZ, LLP, P O BOX 2207, WILMINGTON, DE, 19899, US

(73) Assignee: BASF Fuel Cell GmbH, Frankfurt am Main (DE)

(21) Appl. No.: 11/913,574

(22) PCT Filed: May 3, 2006
(86) PCT No.: PCT/EP2006/004122

§ 371 Date: Mar. 3, 2008

(30) Foreign Application Priority Data
May 3, 2005 (DE) 10 2005 020 604.2

(51) Int. Cl. H01M 8/10; H01M 8/02

(52) U.S. Cl. 429/30; 429/34; 29/623.1

(57) ABSTRACT

The invention relates to a single fuel cell, comprising a) at least two electrochemically active electrodes, separated by a polymer electrolyte membrane and b) at least two separator plates, having at least one respective gas channel for reaction gases, whereby at least one separator plate is composed of glassy carbon. Said invention also relates to methods for producing said single fuel cell as well as to fuel cells, comprising such a single fuel cell.

Polymer electrolyte membrane (PEM) fuel cells are already known. In these, the proton-conducting membranes used are nowadays almost without exception polymers modified with sulphonic acids. The polymers employed are predominantly perfluorinated polymers. One prominent example is Nafion™ from DuPont de Nemours, Willmington USA. Proton conduction requires a relatively high water content in the membrane, typically of 4-20 molecules of water per sulphonic acid group. The necessary water content, but also the stability of the polymer in conjunction with acidic water and the reaction gases (hydrogen and oxygen) usually limits the operating temperature of the PEM fuel cell stack to 80-100° C. The operating temperatures can be raised to >120° C. under pressure, but otherwise higher operating temperatures are impossible to realize without a loss of fuel cell performance.

For technical reasons associated with the system, however, operating temperatures higher than 100° C. in the fuel cell are desirable. The activity of the precious-metal-based catalysts contained in the membrane electrode unit (MEU) is much better at high operating temperatures. Particularly when using so-called reformates comprising hydrocarbons, the reformer gas contains significant quantities of carbon monoxide, which usually have to be removed by complex gas processing or gas purification. At high operating temperatures, there is a rise in the tolerance of the catalysts for the CO impurities.

Furthermore, heat is produced during the operation of fuel cells. However, it can be very difficult to cool these systems to below 80° C. Depending on performance output, the cooling devices can designed in a much simpler way. This means that, in fuel cell systems operated at temperatures above 100° C., much better use can be made of the waste heat and therefore the efficiency of the fuel cell system can be increased by means of current/heat coupling.

In order to achieve these temperatures, membranes with new conductivity mechanisms are generally used. One approach to this is the use of membranes which exhibit electrical conductivity without the use of water. The first promising development in this direction is outlined in the document WO96/13872.

Since the voltage that can be tapped off from a single fuel cell is relatively low, generally a plurality of membrane electrode assemblies are connected in series and are joined to one another via flat separator plates (bipolar plates). These separator plates can be made of graphite and can be provided with gas channels for supplying the reaction gases. Here, the graphite plates must usually have a minimum thickness of 1.0 mm in order to ensure that the two reaction gases are supplied separately from one another and are not mixed with one another due to diffusion of one or both reaction gases through the separator plate.

The separator plates can also be obtained by the injection-moulding or press-forming of graphite-containing polymer composite materials. Since such separator plates have a relatively high gas permeability, they must once again usually have a minimum thickness of 1.0 mm in order to ensure that the two reaction gases are supplied separately from one another and are not mixed with one another due to diffusion of one or both reaction gases through the separator plate. Furthermore, the presence of the polymer component in the separator plates reduces the high-temperature properties of the separator plates, in particular the dimensional stability under heat and the structural integrity of the separator plates, and also increases the sensitivity of the separator plates to corrosion.

The above-described minimum thickness of the separator plate leads to a significant increase in the minimum thickness and minimum weight of a fuel cell, which considerably restricts its usability, particularly for applications in which the lowest possible weight and/or the lowest possible volume of the fuel cell is of great importance. Furthermore, the production of the graphite plates, and particularly the milling of the gas channels, is relatively time-consuming and cost-intensive.

Particularly for applications in which the lowest possible weight and/or the lowest possible volume of the fuel cell is of great importance, therefore, there is a need for fuel cells which have a reduced weight and/or volume and which can be produced as easily as possible, on an industrial scale and for the lowest possible cost.

A first approach to solving this problem is provided in the Japanese patent application JP59127377. It proposes using a fuel cell which is composed of a plurality of single fuel cells, wherein the single fuel cells are connected to one another via separator plates made of glassy carbon. In this case, each single fuel cell comprises an electrolyte, for example a phosphate solution, and two electrodes which consist of a porous gas diffusion layer and a suitable catalyst, for example platinum. The electrode surfaces which are not in contact with the electrolyte are provided with gas channels for the reaction gases, hydrogen and oxygen, said gas channels in turn being covered by the separator plates.

However, one disadvantage of this solution is the relatively time-consuming and cost-intensive production of the gas diffusion layers and the increased quantities of catalyst which are required to impregnate the gas diffusion layers.

The prior art also discloses fuel cells which comprise gas diffusion layers made of glassy carbon and separator plates made of graphite, see for example EP 0 328 135, or glassy-carbon-coated gas diffusion layers made of compressed expandable graphite and conventional separator plates made for example of graphite, see e.g. CA 2 413 066. These have in particular the above-described disadvantages resulting from the use of graphite plates.

There is therefore a need for fuel cells which have a reduced weight and/or volume and which can be produced as easily as possible, on an industrial scale and for the lowest possible cost.

The object of the invention was therefore to provide fuel cells having the lowest possible weight and/or the lowest possible volume, which can be produced as easily as possible, on an industrial scale and for the lowest possible cost.

The fuel cells here should preferably have the following properties:
The fuel cells should have as long a service life as possible.
The fuel cells should be able to be used at operating temperatures that are as high as possible, in particular above 100° C.
The single cells should exhibit during operation a constant or improved performance for a period that is as long as possible.
The fuel cells should have, after a long operating time, a resting voltage that is as high as possible and a gas cross-over that is as low as possible. They should also be able to be operated with a stoichiometry that is as low as possible.
The fuel cells should as far as possible manage without additional wetting of the combustion gas.
The fuel cells should be able to withstand as best as possible any permanent or variable pressure differences between the anode and the cathode.
In particular, the fuel cells should be robust against different operating conditions (T, p, geometry, etc.), so as to increase the general reliability as best as possible.
Furthermore, the fuel cells should have an improved resistance to heat and corrosion and should have a relatively low gas permeability, particularly at high temperatures. Any reduction in mechanical stability and structural integrity, particularly at high temperatures, should be avoided as best as possible.
The fuel cells should be able to be produced as easily as possible, on an industrial scale and for the lowest possible cost.

These objects are achieved by a single fuel cell having all the features of claim 1.

The subject matter of the present invention is accordingly a single fuel cell, comprising
a) at least two electrochemically active electrodes which are separated by a polymer electrolyte membrane, and
b) at least two separator plates which in each case have at least one gas channel for reaction gases,
   wherein at least one separator plate comprises glassy carbon.

Polymer electrolyte membranes which are suitable for the purposes of the present invention are known per se and are in principle not subject to any limitation. Rather, all proton-conducting materials are suitable. Preferably, however, use is made of membranes which comprise acids, wherein the acids may be covalently bonded to polymers. Furthermore, a sheet-like material may be doped with an acid in order to form a suitable membrane. It is also possible to use gels, in particular polymer gels, as a membrane, with polymer membranes which are particularly suitable for the present purposes being described for example in DE 102 464 61.

These membranes may be produced inter alia by swelling sheet-like materials, for example a polymer film, with a liquid which comprises acid-containing compounds, or by preparing a mixture of polymers and acid-containing compounds and then forming a membrane by shaping a sheet-like object and then solidifying it in order to form a membrane.

The polymers suitable for this include inter alia polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene (PTFE), polyhexafluoropropylene, copolymers of PTFE with hexafluoropropylene, with perfluoropropyl vinyl ether, with trifluoronitrosomethane, with carbalkoxy-perfluoroalkoxy vinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornene;

polymers with C—O bonds in the main chain, for example polyacetal, polyoxymethylene, polyethers, polypropylene oxide, polyepichlorohydrin, polytetrahydrofuran, polyphenylene oxide, polyether ketone, polyesters, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
polymers with C—S bonds in the main chain, for example polysulphide ethers, polyphenylene sulphide, polysulphones, polyethersulphone;
polymers with C—N bonds in the main chain, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid crystalline polymers, in particular Vectra™, and also
inorganic polymers, for example polysilanes, polycarbosilanes, polysiloxanes, polysilicic acid, polysilicates, silicones, polyphosphazenes and polythiazyl.

Here, preference is given to basic polymers, wherein this applies in particular for membranes which are doped with acids. Suitable basic polymer membranes which are doped with acid include almost all known polymer membranes in which the protons can be transported. Here, preference is given to acids which can convey protons without additional water, e.g. by means of the so-called Grotthus mechanism.

The basic polymer used within the context of the present invention is preferably a basic polymer with at least one nitrogen, oxygen or sulphur atom, preferably at least one nitrogen atom, in a repeating unit. Furthermore, preference is given to basic polymers which comprise at least one heteroaryl group.

According to one preferred embodiment, the repeating unit in the basic polymer contains an aromatic ring with at least one nitrogen atom. The aromatic ring is preferably a five- or six-membered ring with one to three nitrogen atoms, which can be fused to another ring, in particular to another aromatic ring.

According to one particular aspect of the present invention, use is made of high-temperature-stable polymers which contain at least one nitrogen, oxygen and/or sulphur atom in one repeating unit or in different repeating units.

Within the context of the present invention, a polymer is high-temperature-stable if it can be durably used as a polymeric electrolyte in a fuel cell at temperatures above 120° C. “Durably” means that a membrane according to the invention can be operated for at least 100 hours, preferably at least 500 hours, at a temperature of at least 80° C., preferably at least 120° C., particularly preferably at least 160° C., without the output, which can be measured according to the method described in WO 01/18894 A2, decreasing by more than 50% relative to the initial output.

Within the context of the present invention, all the abovementioned polymers can be used individually or as a blend. Here, particular preference is given to blends which contain polyazoles and/or polysulphones. The preferred blend components are polyethersulphone, polyether ketone and polymers modified with sulphonic acid groups, as described in German patent application DE 100 522 42 and DE 102 464 61. By using blends, it is possible to improve the mechanical properties and reduce the material costs.

Furthermore, polymer blends which comprise at least one basic polymer and at least one acidic polymer, preferably in a weight ratio of 1:99 to 99:1 (so-called acid/base polymer blends), have also proven to be particularly useful for the purposes of the present invention. Acidic polymers which are particularly suitable in this connection are polymers which contain sulphonic acid groups and/or phosphonic acid groups. Acid/base polymer blends which are very particularly suitable according to the invention are described in detail for example in the document EP1073690 A1.

One particularly preferred group of basic polymers is polyazoles. A basic polymer based on polyazole contains repeating azole units of general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

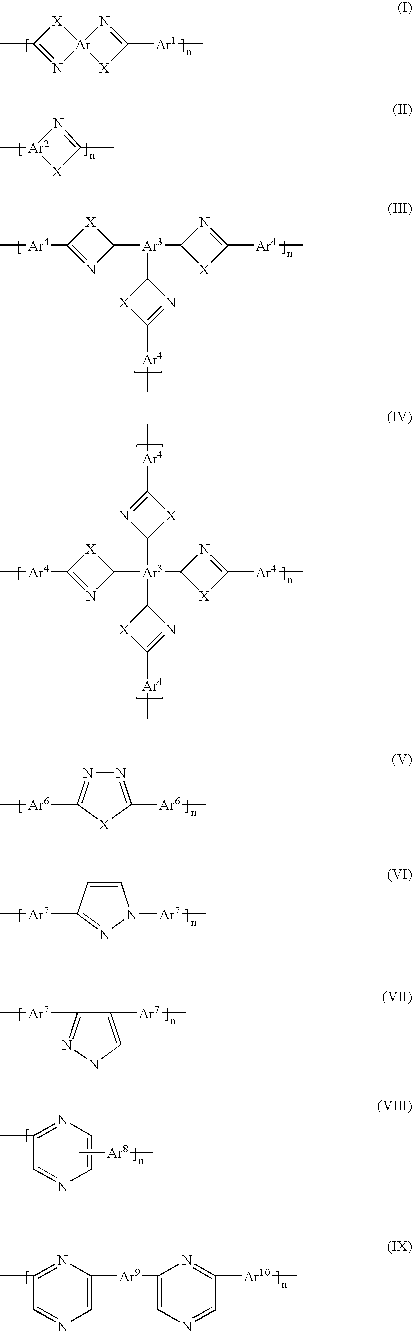

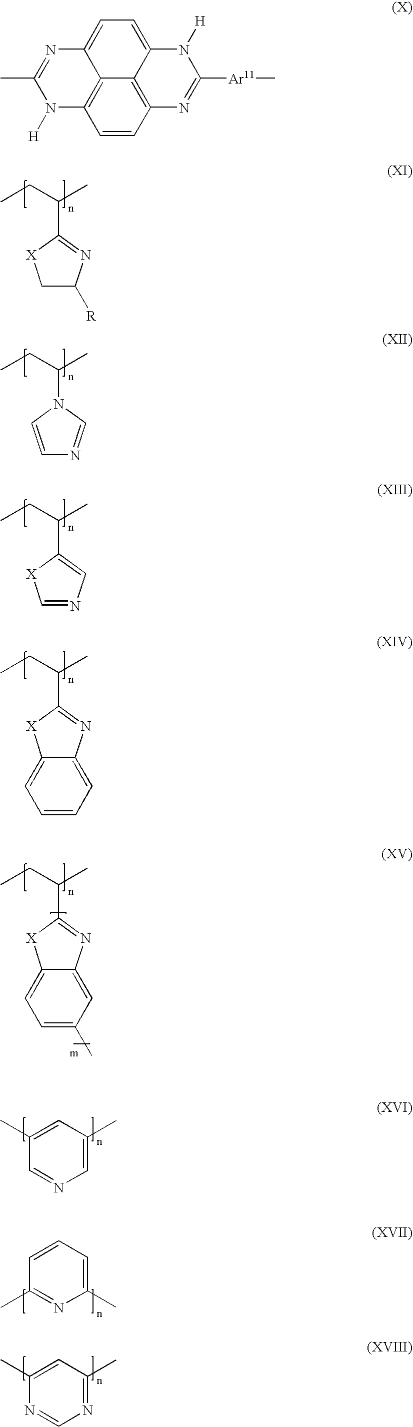

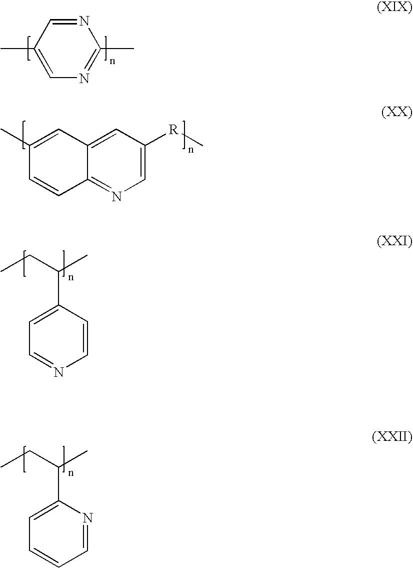

in which
Ar are identical or different and denote a tetravalent aromatic or heteroaromatic group, which may be mononuclear or polynuclear,
Ar¹ are identical or different and denote a divalent aromatic or heteroaromatic group, which may be mononuclear or polynuclear,
Ar² are identical or different and denote a divalent or trivalent aromatic or heteroaromatic group, which may be mononuclear or polynuclear,
Ar³ are identical or different and denote a trivalent aromatic or heteroaromatic group, which may be mononuclear or polynuclear,
Ar⁴ are identical or different and denote a trivalent aromatic or heteroaromatic group, which may be mononuclear or polynuclear,
Ar⁵ are identical or different and denote a tetravalent aromatic or heteroaromatic group, which may be mononuclear or polynuclear,
Ar⁶ are identical or different and denote a divalent aromatic or heteroaromatic group, which may be mononuclear or polynuclear,
Ar⁷ are identical or different and denote a divalent aromatic or heteroaromatic group, which may be mononuclear or polynuclear,
Ar⁸ are identical or different and denote a trivalent aromatic or heteroaromatic group, which may be mononuclear or polynuclear,
Ar⁹ are identical or different and denote a divalent, trivalent or tetravalent aromatic or heteroaromatic group, which may be mononuclear or polynuclear,
Ar¹⁰ are identical or different and denote a divalent or trivalent aromatic or heteroaromatic group, which may be mononuclear or polynuclear,
Ar¹¹ are identical or different and denote a divalent aromatic or heteroaromatic group, which may be mononuclear or polynuclear,
X is identical or different and denotes oxygen, sulphur or an amino group which carries a hydrogen atom, a group containing 1-20 carbon atoms, preferably a branched or unbranched alkyl group or alkoxy group, or an aryl group as further radical,
R in all formulae except formula (XX) is identical or different and denotes hydrogen, an alkyl group or an aromatic group, and in formula (XX) denotes an alkylene group or an aromatic group, and
n, m is a whole number greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may optionally also be substituted.

In this connection, the substitution pattern of Ar¹, Ar⁴, Ar⁶, Ar⁷, Ar⁸, Ar⁹, Ar¹⁰, Ar¹¹ is arbitrary, and in the case of phenylene for example Ar¹, Ar⁴, Ar⁶, Ar⁷, Ar⁸, Ar⁹, Ar¹⁰, Ar¹¹ may be ortho-phenylene, meta-phenylene and para-phenylene. Particularly preferred groups are derived from benzene and biphenylene, which may optionally also be substituted.

Preferred alkyl groups are short-chain alkyl groups with 1 to 4 carbon atoms, such as e.g. methyl, ethyl, n-propyl or i-propyl and t-butyl groups.

Preferred aromatic groups are phenyl or naphthyl groups. The alkyl groups and the aromatic groups may be substituted.

Preferred substituents are halogen atoms such as e.g. fluorine, amino groups, hydroxyl groups or short-chain alkyl groups such as e.g. methyl or ethyl groups.

Preference is given to polyazoles with repeating units of formula (I) in which the radicals X within a repeating unit are identical.

The polyazoles may in principle also contain different repeating units, which differ for example in their radical X. However, it preferably has only identical radicals X in a repeating unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In a further embodiment of the present invention, the polymer containing repeating azole units is a copolymer or a blend which contains at least two units of formula (I) to (XXII) which differ from one another. The polymers may be present as block copolymers (diblock, triblock), random copolymers, periodic copolymers and/or alternating polymers.

In one particularly preferred embodiment of the present invention, the polymer containing repeating azole units is a polyazole which contains only units of formula (I) and/or (II).

The number of repeating azole units in the polymer is preferably a whole number greater than or equal to 10. Particularly preferred polymers contain at least 100 repeating azole units.

Within the context of the present invention, preference is given to polymers containing repeating benzimidazole units. Some examples of the extremely suitable polymers containing repeating benzimidazole units are shown by the following formulae:

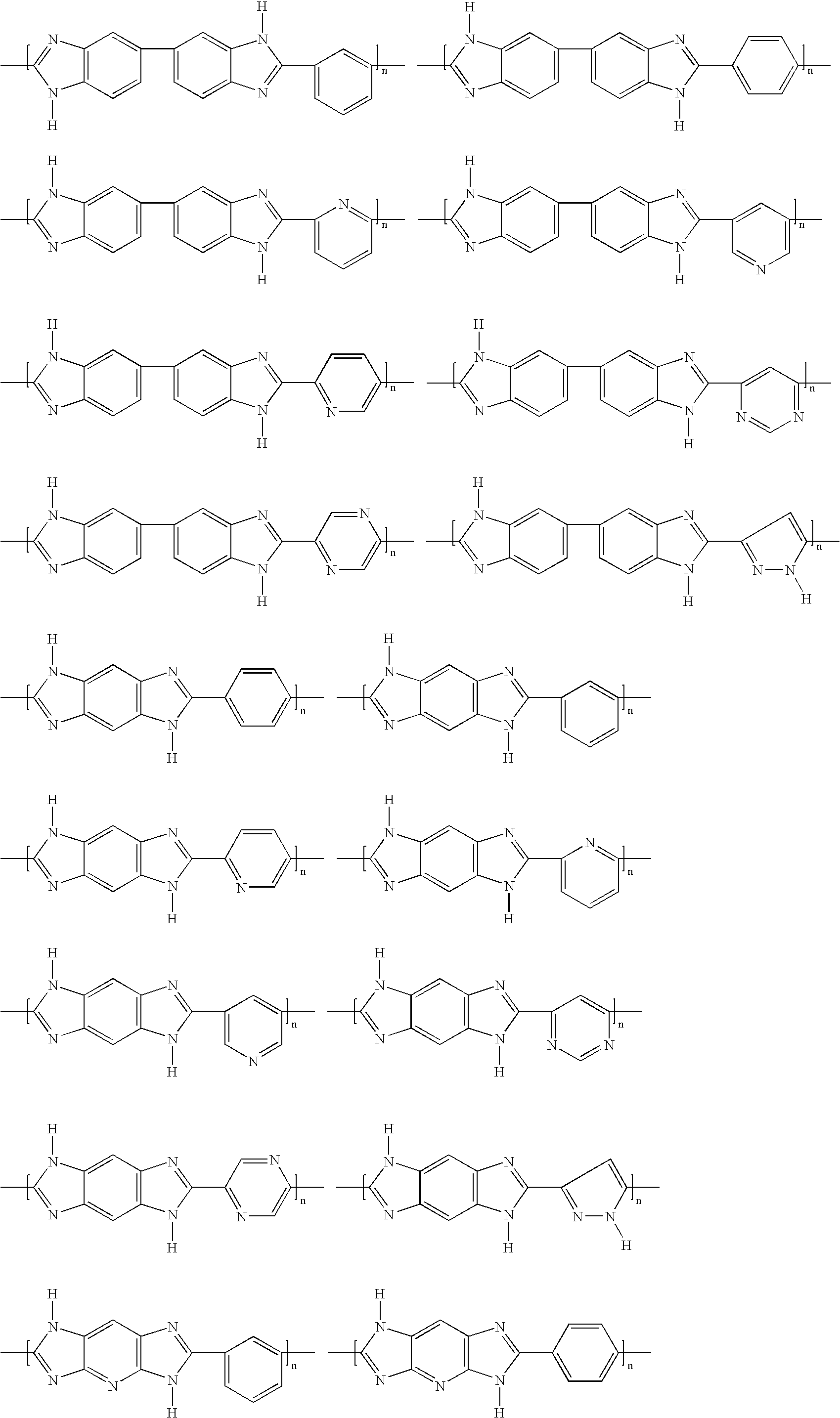

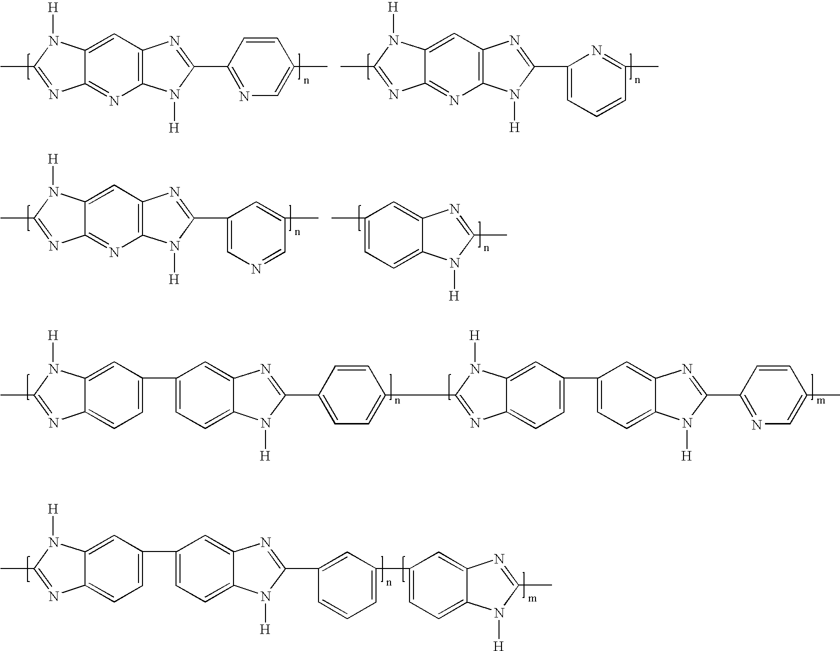

wherein n and m are whole numbers greater than or equal to 10, preferably greater than or equal to 100.

The polyazoles used, but in particular the polybenzimidazoles, are characterized by a high molecular weight. Measured as intrinsic viscosity, this is preferably at least 0.2 dl/g, preferably 0.8 to 10 dl/g, in particular 1 to 10 dl/g.

The preparation of such polyazoles is known, wherein one or more aromatic tetraamino compounds is reacted with one or more aromatic carboxylic acids or esters thereof, which contain at least two acid groups per carboxylic acid monomer, in the melt to form a prepolymer. The resulting prepolymer solidifies in the reactor and is then mechanically comminuted. The pulverulent prepolymer is usually end-polymerized in a solid phase polymerization at temperatures of up to 400° C.

The preferred aromatic carboxylic acids include inter alia dicarboxylic acids and tricarboxylic acids and tetracarboxylic acids and esters thereof or anhydrides thereof or acid chlorides thereof. The term “aromatic carboxylic acids” also encompasses heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthaic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenoic acid, 1,8-dihydroxynaphthalene-3,6-dicarboxylic acid, diphenylether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)-hexafluoropropane, 4,4′-stilbenedicarboxylic acid, 4-carboxycinnamic acid, or the C1-C20 alkyl esters or C5-C12 aryl esters thereof, or the acid anhydrides thereof or the acid chlorides thereof.

The aromatic tricarboxylic acids or tetracarboxylic acids or the C1-C20 alkyl esters or C5-C12 aryl esters thereof or the acid anhydrides thereof or the acid chlorides thereof are preferably 1,3,5-benzenetricarboxylic acid (trimesic acid), 1,2,4-benzenetricarboxylic acid (trimellitic acid), (2-carboxyphenyl)iminodiacetic acid, 3,5,3-biphenyltricarboxylic acid or 3,5,4′-biphenyltricarboxylic acid.

The aromatic tetracarboxylic acids or the C1-C20 alkyl esters or C5-C12 aryl esters thereof or the acid anhydrides thereof or the acid chlorides thereof are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids used are preferably heteroaromatic dicarboxylic acids or tricarboxylic acids or tetracarboxylic acids or the esters thereof or the anhydrides thereof. Heteroaromatic carboxylic acids are understood to mean aromatic systems which contain at least one nitrogen, oxygen, sulphur or phosphorus atom in the aromatic ring. These are preferably pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid or the C1-C20 alkyl esters or C5-C12 aryl esters thereof or the acid anhydrides thereof or the acid chlorides thereof.

The content of tricarboxylic acid or tetracarboxylic acid (relative to the dicarboxylic acid used) is between 0 and 30 mol %, preferably 0.1 and 20 mol %, in particular 0.5 and 10 mol %.

The aromatic and heteroaromatic diaminocarboxylic acids used are preferably diaminobenzoic acid or the mono- and dihydrochloride derivatives thereof.

Preferably, mixtures of at least 2 different aromatic carboxylic acids are used. With particular preference, use is made of mixtures which contain, in addition to aromatic carboxylic acids, also heteroaromatic carboxylic acids. The mixing ratio of aromatic carboxylic acids to heteroaromatic carboxylic acids is between 1:99 and 99:1, preferably 1:50 to 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenoic acid, 1,8-dihydroxynaphthalene-3,6-dicarboxylic acid, diphenylether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetraamino compounds include inter alia 3,3′,4,4′-tetraminobiphenyl, 2,3,5,6-tetraminopyridine, 1,2,4,5-tetraminobenzene, 3,3′,4,4′-tetraminodiphenylsulphone, 3,3,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane, and also the salts thereof, in particular the mono-, di-, tri- and tetrahydrochloride derivatives thereof.

Preferred polybenzimidazoles are commercially available under the trade name ®Celazole from Celanese AG.

The preferred polymers include polysulphones, in particular polysulphone with aromatic and/or heteroaromatic groups in the main chain. According to one particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured according to ISO 1133. In this connection, preference is given to polysulphones with a Vicat softening temperature VST/A/50 of 180° C. to 230° C. In another preferred embodiment of the present invention, the number average molecular weight of the polysulphones is greater than 30,000 g/mol.

Polymers based on polysulphone include in particular polymers which have repeating units with linking sulphone groups corresponding to the general formulae A, B, C, D, E, F and/or G:

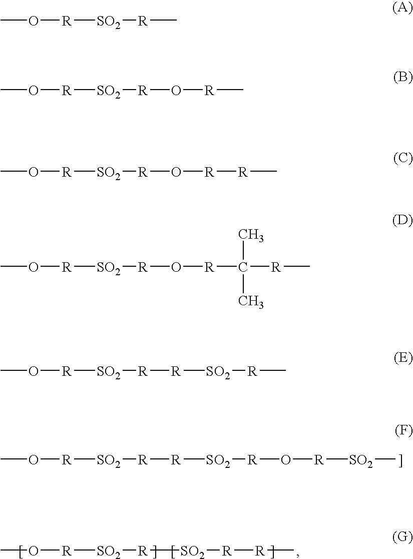

in which the radicals R independently of one another are identical or different and denote an aromatic or heteroaromatic group, these radicals having been described in detail above. These radicals include in particular 1,2-phenylene, 1,3-phenylene, 1,4-phenylene, 4,4′-biphenyl, pyridine, quinoline, naphthalene, phenanthrene.

The polysulphones which are preferred within the context of the present invention include homopolymers and copolymers, for example random copolymers. Particularly preferred polysulphones comprise repeating units of formulae H to N:

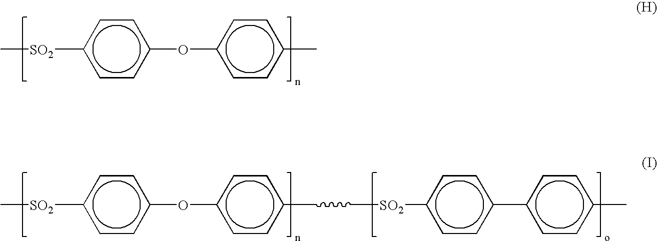

where n>o

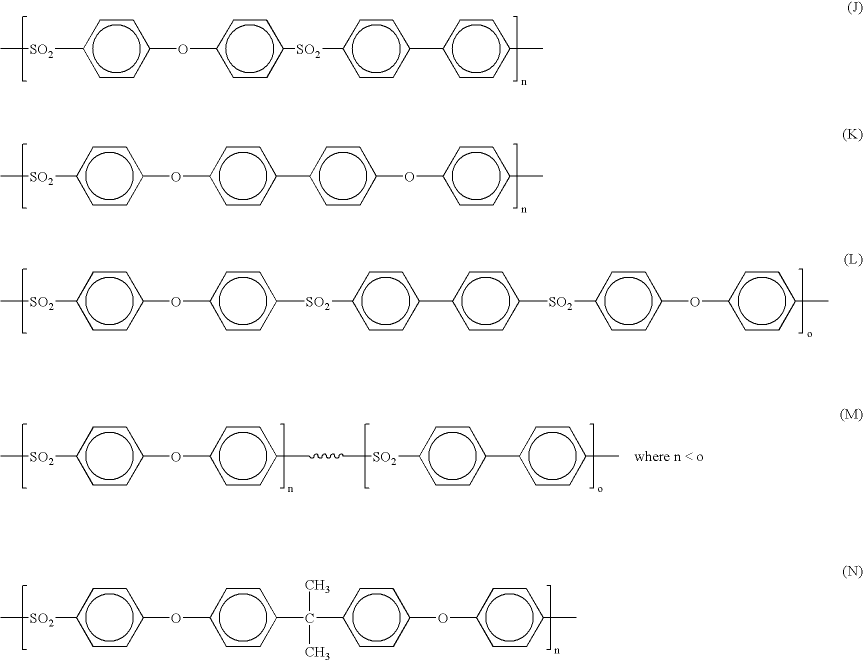

The above-described polysulphones can be commercially obtained under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, particular preference is given to polyether ketones, polyether ketone ketones, polyether ether ketones, polyether ether ketone ketones and polyaryl ketones. These high-performance polymers are known per se and can be commercially obtained under the trade names Victrex® PEEK™, ®Hostatec, ®Kadel.

In order to prepare polymer films, a polymer, preferably a polyazole, may in a further step be dissolved in polar, aprotic solvents, such as e.g. dimethylacetamide (DMAc), and a film can be produced by means of conventional methods.

In order to remove solvent residues, the film thus obtained may be treated with a washing liquid, as in the German patent application DE 101 098 29. By cleaning the polyazole film of solvent residues as described in the German patent application, the mechanical properties of the film are surprisingly improved. These properties include in particular the modulus of elasticity, the tear strength and the breaking resistance of the film.

In addition, the polymer film may have further modifications, for example as a result of crosslinking, as described in the German patent application DE 101 107 52 or in WO 00/44816. In one preferred embodiment, the polymer film used contains, in addition to a basic polymer and at least one blend component, additionally a crosslinker, as described in the German patent application DE 101 401 47.

The thickness of the polyazole films may lie within wide ranges. Preferably, the thickness of the polyazole film prior to doping with acid lies in the range from 5 μm to 2000 μm, particularly preferably in the range from 10 μm to 1000 μm, without this being intended to represent any limitation.

In order to achieve proton conductivity, these films are doped with an acid. Acids in this connection include all known Lewis and Brønsted acids, preferably inorganic Lewis and Brønsted acids.

The use of polyacids is also possible, in particular isopolyacids and heteropolyacids, and mixtures of various acids. Within the context of the present invention, heteropolyacids denote inorganic polyacids with at least two different central atoms, which are formed from weak, multibasic oxygen acids of a metal (preferably Cr, Mo, V, W) and a non-metal (preferably AS, I, P, Se, Si, Te) as partial mixed anhydrides. These include inter alia 12-molybdatophosphoric acid and 12-tungstophosphoric acid.

The conductivity of the polyazole film can be influenced via the degree of doping. In this connection, the conductivity increases as the concentration of doping agent increases, until a maximum value is reached.

According to the invention, the degree of doping is given as moles of acid per mole of repeating unit of the polymer. Within the context of the present invention, preference is given to a degree of doping of between 3 and 80, advantageously between 5 and 60, in particular between 12 and 60.

Particularly preferred doping agents are sulphuric acid and phosphoric acid and compounds which release these acids, for example upon hydrolysis. One doping agent which is very particularly preferred is phosphoric acid (H₃PO₄). In this connection, use is generally made of highly concentrated acids. According to one particular aspect of the present invention, the concentration of phosphoric acid is at least 50% by weight, in particular at least 80% by weight, relative to the weight of the doping agent.

Furthermore, proton-conducting membranes can also be obtained by a method comprising the following steps
I) dissolving polymers, in particular polyazoles, in polyphosphoric acid,
II) heating the solution obtainable according to step I) under inert gas to temperatures of up to 400° C.,
III) forming a membrane using the solution of the polymer according to step II) on a support, and
IV) treating the membrane formed in step III) until it is self-supporting.

Further details regarding such proton-conducting membranes can be found for example in DE 102 464 61. They are obtainable for example under the trade name Celtec®.

Furthermore, doped polyazole films can be obtained by a method comprising the following steps
A) mixing one or more aromatic tetraamino compounds with one or more aromatic carboxylic acids or esters thereof which contain at least two acid groups per carboxylic acid monomer, or mixing one or more aromatic and/or heteroaromatic diaminocarboxylic acids in polyphosphoric acid to form a solution and/or dispersion,
B) applying a layer using the mixture according to step A) to a support or to an electrode,
C) heating the sheet-like structure/layer obtainable according to step B) under inert gas to temperatures of up to 350° C., preferably up to 280° C., to form the polyazole polymer,
D) treating the membrane formed in step C) (until it is self-supporting).

Further details regarding such proton-conducting membranes can be found for example in DE 102 464 59. They are obtainable for example under the trade name Celtec®.

The aromatic or heteroaromatic carboxylic acid and tetraamino compounds to be used in step A) have been described above.

The polyphosphoric acid used in step A) is a commercially available polyphosphoric acid as can be obtained for example from Riedel-de-Haen. The polyphosphoric acids Hₙ₊₂PₙO₃ₙ₊₁ (n>1) usually have a content calculated as P₂O₆ (acidimetrically) of at least 83%. Instead of a solution of the monomers, it is also possible for a dispersion/suspension to be produced.

The mixture produced in step A) has a weight ratio of polyphosphoric acid to the sum of all monomers of 1:10,000 to 10, 000:1, preferably 1:1000 to 1000:1, in particular 1:100 to 100:1.

The layer formation according to step B) is carried out by means of measures known per se (casting, spraying, knife-coating) which are known from the prior art in relation to polymer film production. Suitable supports are all supports which can be referred to as inert under the conditions. In order to adjust the viscosity, phosphoric acid (concentrated phosphoric acid, 85%) can optionally be added to the solution. As a result, the viscosity can be adjusted to the desired value and the formation of the membrane can be facilitated.

The layer produced according to step B) has a thickness between 20 and 4000 μm, preferably between 30 and 3500 μm, in particular between 50 and 3000 μm.

If the mixture according to step A) also contains tricarboxylic acids or tetracarboxylic acid, a branching/crosslinking of the polymers formed is achieved as a result. This helps to improve the mechanical properties.

Treatment of the polymer layer produced according to step C) in the presence of moisture at temperatures and for a duration sufficient for the layer to have a sufficient strength for use in fuel cells. The treatment may be carried out until the membrane is self-supporting, so that it can be detached from the support without any damage.

According to step C), the sheet-like structure obtained in step B) is heated to a temperature of up to 350° C., preferably up to 280° C. and particularly preferably in the range from 200° C. to 250° C. The inert gases to be used in step C) are known in specialist circles. These include in particular nitrogen and also noble gases such as neon, argon, helium.

In one variant of the method, the formation of oligomers and/or polymers can be brought about simply by heating the mixture from step A) to temperatures of up to 350° C., preferably up to 280° C. Depending on the selected temperature and duration, the heating in step C) can then be partially or completely omitted. This variant also forms the subject matter of the present invention.

The treatment of the membrane in step D) is carried out at temperatures above 0° C. and below 150° C., preferably at temperatures between 10° C. and 120° C., in particular between room temperature (20° C.) and 90° C., in the presence of moisture or water and/or water vapour and/or water-containing phosphoric acid of up to 85%. The treatment is preferably carried out under normal pressure, but may also be carried out under the effect of pressure. The important thing is that the treatment takes place in the presence of sufficient moisture, as a result of which the polyphosphoric acid that is present helps to solidify the membrane as a result of partial hydrolysis to form low-molecular-weight polyphosphoric acid and/or phosphoric acid.

The partial hydrolysis of the polyphosphoric acid in step D) leads to a solidification of the membrane and to a reduction in layer thickness and the formation of a membrane having a thickness of between 15 and 3000 μm, preferably between 20 and 2000 μm, in particular between 20 and 1500 μm, which is self-supporting.

The intramolecular and intermolecular structures (interpenetrating networks IPN) present in the polyphosphoric acid layer according to step B) lead in step C) to an ordered membrane formation, which is responsible for the particular properties of the membrane formed.

The upper temperature limit of the treatment according to step D) is generally 150° C. In the event of an extremely short exposure to moisture, for example superheated steam, this steam may also be hotter than 150° C. The important factor for the temperature upper limit is the duration of the treatment.

The partial hydrolysis (step D) may also take place in climate-controlled chambers, in which the hydrolysis can be controlled in a targeted manner under defined moisture conditions. Here, the moisture can be adjusted in a targeted manner via the temperature and saturation of the contacting environment, for example gases such as air, nitrogen, carbon dioxide or other suitable gases, or water vapour. The treatment duration is dependent on the parameters selected above.

The treatment duration is also dependent on the thickness of the membrane.

Usually, the treatment duration is between a few seconds to minutes, for example under the influence of superheated steam, or up to whole days, for example when carried out in air at room temperature and with low relative humidity. Preferably, the treatment duration is between 10 seconds and 300 hours, in particular 1 minute to 200 hours.

If the partial hydrolysis is carried out at room temperature (20° C.) with ambient air having a relative humidity of 40-80%, the treatment duration is between 1 and 200 hours.

The membrane obtained according to step D) may be designed to be self-supporting, i.e., it can be detached from the support without any damage and then further processed directly if necessary.

The concentration of phosphoric acid and thus the conductivity of the polymer membrane can be adjusted via the degree of hydrolysis, i.e. the duration, temperature and ambient humidity. The concentration of the phosphoric acid is given as moles of acid per mole of repeating unit of the polymer. Membranes with a particularly high phosphoric acid concentration can be obtained by the method comprising steps A) to D). Preference is given to a concentration (moles of phosphoric acid relative to a repeating unit of formula (I), for example polybenzimidazole) of between 10 and 50, in particular between 12 and 40. Such high degrees of doping (concentrations) cannot be achieved or can be achieved only with great difficult by doping polyazoles with commercially available ortho-phosphoric acid.

According to one modification of the method described above, in which doped polyazole films are produced by using polyphosphoric acid, the production of these films may also be carried out by a method comprising the following steps
1) reacting one or more aromatic tetraamino compounds with one or more aromatic carboxylic acids or esters thereof which contain at least two acid groups per carboxylic acid monomer, or reacting one or more aromatic and/or heteroaromatic diaminocarboxylic acids in the melt at temperatures of up to 350° C., preferably up to 300° C.,
2) dissolving the solid pre-polymer obtained according to step 1) in polyphosphoric acid,
3) heating the solution obtainable according to step 2) under inert gas to temperatures of up to 300° C., preferably up to 280° C., to form the dissolved polyazole polymer,
4) forming a membrane using the solution of the polyazole polymer according to step 3) on a support, and
5) treating the membrane formed in step 4) until it is self-supporting.

The method steps presented under points 1) to 5) have been described in greater detail above in respect of steps A) to D), to which reference is hereby made in particular with regard to preferred embodiments.

Further details regarding such proton-conducting membranes can be found for example in DE 102 464 59. They are obtainable for example under the trade name Celtec®.

In a further preferred embodiment of the present invention, use is made of membranes which comprise polymers derived from monomers containing phosphonic acid groups and/or monomers containing sulphonic acid groups, and which are obtainable for example under the trade name Celtec®.

These proton-conducting polymer membranes are obtainable inter alia by a method described for example in DE 102 135 40, said method comprising the following steps
A) preparing a mixture comprising at least one polymer and monomers containing phosphonic acid groups,
B) applying a layer using the mixture according to step A) to a support,
C) polymerizing the monomers containing phosphonic acid groups which are present in the sheet-like structure obtainable according to step B).

Furthermore, such proton-conducting polymer membranes are obtainable by a method described for example in DE 102 094 19, said method comprising the following steps
I) swelling a polymer film with a liquid which contains monomers containing phosphonic acid groups,
II) polymerizing at least some of the monomers containing phosphonic acid groups which have been incorporated in the polymer film in step I).

Swelling is to be understood to mean an increase in weight of the film by at least 3% by weight. The swelling is preferably at least 5%, particularly preferably at least 10%.

The swelling Q is determined gravimetrically from the mass of the film prior to swelling m₀ and the mass of the film after the polymerization according to step B), m₂.

Q=(m₂−m₀)/m₀×100

The swelling preferably takes place at a temperature above 0° C., in particular between room temperature (20° C.) and 180° C. in a liquid which preferably contains at least 5% by weight of monomers containing phosphonic acid groups. Furthermore, the swelling may also be carried out at an increased pressure. In this connection, the limits result from economic considerations and technical possibilities.

The polymer film used for swelling generally has a thickness in the range from 5 to 3000 μm, preferably 10 to 1500 μm. The production of such films from polymers is generally known, with some of these being commercially available. The term “polymer film” means that the film to be used for swelling comprises polymers with aromatic sulphonic acid groups, it also being possible for this film to contain further generally customary additives.

The production of the films and also preferred polymers, in particular polyazoles and/or polysulphones, have been described above.

The liquid which contains monomers containing phosphonic acid groups and/or monomers containing sulphonic acid groups may be a solution, it also being possible for the liquid also to contain suspended and/or dispersed components. The viscosity of the liquid which contains monomers containing phosphonic acid groups may lie within wide ranges, wherein an addition of solvents or an increase in temperature may take place in order to adjust the viscosity. The dynamic viscosity preferably lies in the range from 0.1 to 10,000 mPa*s, in particular 0.2 to 2000 mPa*s, wherein these values may be measured for example according to DIN 53015.

Monomers containing phosphonic acid groups and/or monomers containing sulphonic acid groups are known in specialist circles. These are compounds which have at least one carbon-carbon double bond and at least one phosphonic acid group. Preferably, the two carbon atoms which form the carbon-carbon double bond have at least two, preferably three bonds to groups which lead to low steric hindrance of the double bond. These groups include, inter alia, hydrogen atoms and halogen atoms, in particular fluorine atoms. Within the context of the present invention, the polymer containing phosphonic acid groups is formed from the polymerization product which is obtained by polymerization of the monomer containing phosphonic acid groups either alone or with further monomers and/or crosslinkers.

The monomer containing phosphonic acid groups may comprise one, two, three or more carbon-carbon double bonds. Furthermore, the monomer containing phosphonic acid groups may contain one, two, three or more phosphonic acid groups.

In general, the monomer containing phosphonic acid groups contains 2 to 20, preferably 2 to 10 carbon atoms.

The monomer containing phosphonic acid groups which is used to produce the polymer containing phosphonic acid groups is preferably a compound of the formula

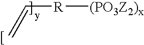

in which
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, an ethyleneoxy group or a C5-C20 aryl or heteroaryl group, the aforementioned radicals in turn optionally being substituted by halogen, —OH, —CN, and
x is a whole number 1, 2, 3, 4, 5, 6, 7, 8, 9 or 10,
y is a whole number 1, 2, 3, 4, 5, 6, 7, 8, 9 or 10
   and/or of the formula

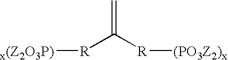

in which
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, —CN, and
X is a whole number 1, 2, 3, 4, 5, 6, 7, 8, 9 or 10
   and/or of the formula

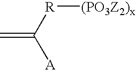

in which
A is a group of formula COOR², CN, CONR²₂, OR² and/or R²,
R² is hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, COOZ, —CN, NZ₂,
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, an ethyleneoxy group or a C5-C20 aryl or heteroaryl group, the aforementioned radicals in turn optionally being substituted by halogen, —OH, —CN, and
x is a whole number 1, 2, 3, 4, 5, 6, 7, 8, 9 or 10.

The preferred monomers containing phosphonic acid groups include, inter alia, alkenes which contain phosphonic acid groups, such as ethenephosphonic acid, propenephosphonic acid, butenephosphonic acid; acrylic acid and/or methacrylic acid compounds which contain phosphonic acid groups, such as for example 2-phosphonomethylacrylic acid, 2-phosphonomethylmethacrylic acid, 2-phosphonomethyl-acrylamide and 2-phosphonomethylmethacrylamide.

With particular preference, use is made of commercially available vinyiphosphonic acid (ethenephosphonic acid), as obtainable for example from Aldrich or Clariant GmbH. A preferred vinylphosphonic acid has a purity of more than 70%, in particular 90% and particularly preferably more than 97%.

Furthermore, the monomers containing phosphonic acid groups can also be used in the form of derivatives which can subsequently be converted into the acid, wherein the conversion into the acid can also be carried out in the polymerized state. These derivatives include in particular the salts, esters, amides and halides of the monomers containing phosphonic acid groups.

The liquid used preferably comprises at least 20% by weight, in particular at least 30% by weight and particularly preferably at least 50% by weight, relative to the total weight of the mixture, of monomers containing phosphonic acid groups and/or monomers containing sulphonic acid groups.

The liquid used may additionally contain further organic and/or inorganic solvents. The organic solvents include, in particular, polar aprotic solvents such as dimethyl sulphoxide (DMSO), esters such as ethyl acetate, and polar protic solvents such as alcohols, such as ethanol, propanol, isopropanol and/or butanol. The inorganic solvents include, in particular, water, phosphoric acid and polyphosphoric acid.

These can have a positive influence on the processability. In particular, the incorporation of the monomer into the film can be improved by adding the organic solvent. The content of monomers containing phosphonic acid groups and/or monomers containing sulphonic acid groups in such solutions is generally at least 5% by weight, preferably at least 10% by weight, particularly preferably between 10 and 97% by weight.

Monomers containing sulphonic acid groups are known in specialist circles. These are compounds which have at least one carbon-carbon double bond and at least one sulphonic acid group. Preferably, the two carbon atoms which form the carbon-carbon double bond have at least two, preferably three bonds to groups which lead to low steric hindrance of the double bond. These groups include, inter alia, hydrogen atoms and halogen atoms, in particular fluorine atoms. Within the context of the present invention, the polymer containing sulphonic acid groups is formed from the polymerization product which is obtained by polymerization of the monomer containing sulphonic acid groups either alone or with further monomers and/or crosslinkers.

The monomer containing sulphonic acid groups may comprise one, two, three or more carbon-carbon double bonds. Furthermore, the monomer containing sulphonic acid groups may contain one, two, three or more sulphonic acid groups.

In general, the monomer containing sulphonic acid groups contains 2 to 20, preferably 2 to 10 carbon atoms.

The monomer containing sulphonic acid groups is preferably a compound of the formula

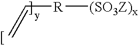

in which
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, —CN, and
x is a whole number 1, 2, 3, 4, 5, 6, 7, 8, 9 or 10,
y is a whole number 1, 2, 3, 4, 5, 6, 7, 8, 9 or 10
   and/or of the formula

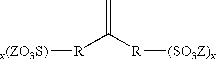

in which
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, —CN, and
x is a whole number 1, 2, 3, 4, 5, 6, 7, 8, 9 or 10
   and/or of the formula

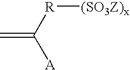

in which
A is a group of formula COOR², CN, CONR²₂, OR² and/or R²,
R² is hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, COOZ, —CN, NZ₂,
R is a bond, a divalent C1-C15 alkylene group, a divalent C1-C15 alkyleneoxy group, for example an ethyleneoxy group, or a divalent C5-C20 aryl or heteroaryl group, the aforementioned radicals in turn optionally being substituted by halogen, —OH, COOZ, —CN, NZ₂,
Z are each, independently of one another, hydrogen, a C1-C15 alkyl group, a C1-C15 alkoxy group, for example an ethyleneoxy group, or a C5-C20 aryl or heteroaryl group, the aforementioned radicals in turn optionally being substituted by halogen, —OH, —CN, and
x is a whole number 1, 2, 3, 4, 5, 6, 7, 8, 9 or 10.

The preferred monomers containing sulphonic acid groups include, inter alia, alkenes which contain sulphonic acid groups, such as ethenesulphonic acid, propenesulphonic acid, butenesulphonic acid; acrylic acid and/or methacrylic acid compounds which contain sulphonic acid groups, such as for example 2-sulphonomethylacrylic acid, 2-sulphonomethyl-methacrylic acid, 2-sulphonomethylacrylamide and 2-sulphonomethylmethacrylamide.

With particular preference, use is made of commercially available vinylsulphonic acid (ethenesulphonic acid), as obtainable for example from Aldrich or Clariant GmbH. A preferred vinylsulphonic acid has a purity of more than 70%, in particular 90% and particularly preferably more than 97% purity.

Furthermore, the monomers containing sulphonic acid groups can also be used in the form of derivatives which can subsequently be converted into the acid, wherein the conversion into the acid can also be carried out in the polymerized state. These derivatives include in particular the salts, esters, amides and halides of the monomers containing sulphonic acid groups.

According to one particular aspect of the present invention, the weight ratio of monomers containing sulphonic acid groups to monomers containing phosphonic acid groups may lie in the range from 100:1 to 1:100, preferably 10:1 to 1:10 and particularly preferably 2:1 to 1:2.

According to a further particular aspect of the present invention, monomers containing phosphonic acid groups are preferred over monomers containing sulphonic acid groups. Accordingly, use is particularly preferably made of a liquid which contains monomers containing phosphonic acid groups.

In a further embodiment of the invention, monomers capable of crosslinking can be used in the production of the polymer membrane. These monomers may be added to the liquid used to treat the film. The monomers capable of crosslinking may also be applied to the sheet-like structure after treatment with the liquid.

The monomers capable of crosslinking are in particular compounds which contain at least 2 carbon-carbon double bonds. Preference is given to dienes, trienes, tetraenes, dimethylacrylates, trimethylacrylates, tetramethyl-acrylates, diacrylates, triacrylates and tetraacrylates.

Particular preference is given to dienes, trienes, tetraenes of the formula

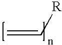

dimethylacrylates, trimethylacrylates, tetramethylacrylates of the formula

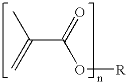

diacrylates, triacrylates, tetraacrylates of the formula

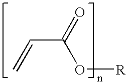

in which
R is a C1-C15 alkyl group, a C5-C20 aryl or heteroaryl group, NR′, —SO₂, PR′, Si(R′)₂, wherein the aforementioned radicals may in turn be substituted,
R′ are each, independently of one another, hydrogen, a C1-C15 alkyl group, a C1-C15 alkoxy group, a C5-C20 aryl or heteroaryl group, and
n is at least 2.

The substituents of the above radical R are preferably halogen, hydroxyl, carboxy, carboxyl, carboxyl ester, nitrile, amine, silyl or siloxane radicals.

Particularly preferred crosslinkers are allyl methacrylate, ethylene glycol dimethacrylate, diethylene glycol dimethacrylate, triethylene glycol dimethacrylate, tetra- and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol-A-dimethylacrylate. These compounds are commercially available for example from Sartomer Company Exton, Pa. under the names CN-120, CN₁₀₄ and CN-980.

The use of crosslinkers is optional, wherein these compounds can usually be used in the range between 0.05 to 30% by weight, preferably 0.1 to 20% by weight, particularly preferably 1 to 10% by weight, relative to the weight of the monomers containing phosphonic acid groups.

The liquid which contains monomers containing phosphonic acid groups and/or monomers containing sulphonic acid groups may be a solution, it also being possible for the liquid also to contain suspended and/or dispersed components. The viscosity of the liquid which contains monomers containing phosphonic acid groups and/or monomers containing sulphonic acid groups may lie within wide ranges, wherein an addition of solvents or an increase in temperature may take place in order to adjust the viscosity. The dynamic viscosity preferably lies in the range from 0.1 to 10,000 mPa*s, in particular 0.2 to 2000 mPa*s, wherein these values may be measured for example according to DIN 53015.

A membrane, in particular a polyazole-based membrane, can also be crosslinked at the surface by the effect of heat in the presence of atmospheric oxygen. This hardening of the membrane surface further improves the properties of the membrane. To this end, the membrane may be heated to a temperature of at least 150° C., preferably at least 200° C. and particularly preferably at least 250° C. The oxygen concentration in this method step usually lies in the range from 5 to 50% by volume, preferably 10 to 40% by volume, without this being intended to represent any limitation.

The crosslinking may also take place by exposure to IR or NIR (IR=infrared, i.e. light with a wavelength of more than 700 nm; NIR=near-IR, i.e. light with a wavelength in the range from approx. 700 to 2000 nm or an energy in the range from approx. 0.6 to 1.75 eV). Another method is exposure to β-rays. The radiation dose here is between 5 and 200 kGy.

Depending on the desired degree of crosslinking, the duration of the crosslinking reaction may lie within a wide range. In general, this reaction time lies in the range from 1 second to 10 hours, preferably 1 minute to 1 hour, without this being intended to represent any limitation.

According to the invention, the single fuel cell comprises at least two electrochemically active electrodes (anode and cathode) which are separated by the polymer electrolyte membrane. The term “electrochemically active” indicates that the electrodes are capable of catalysing the oxidation of hydrogen and/or at least one reformate and the reduction of oxygen. This property may be obtained by coating the electrodes with platinum and/or ruthenium, The term “electrode” means that the material is electrically conductive. The electrode may optionally have a precious metal layer. Such electrodes are known and are described for example in U.S. Pat. No. 4,191,618, U.S. Pat. No. 4,212,714 and U.S. Pat. No. 4,333,805.

The electrodes preferably comprise gas diffusion layers which are in contact with a catalyst layer.

As gas diffusion layers, use is usually made of sheet-like, electrically conductive and acid-resistant structures. These include, for example, graphite fibre papers, carbon fibre papers, woven graphite fabrics and/or papers which have been made conductive by addition of carbon black. A fine distribution of the gas and/or liquid flows is obtained through these layers.

Use may also be made of gas diffusion layers which contain a mechanically stable support material which is impregnated with at least one electrically conductive material, e.g. carbon (for example carbon black). Support materials which are particularly suitable for this purpose include fibres, for example in the form of nonwoven fabrics, papers or woven fabrics, in particular carbon fibres, glass fibres or fibres containing organic polymers, for example polypropylene, polyester (polyethylene terephthalate), polyphenylene sulphide or polyether ketones. Further details concerning such diffusion layers can be found for example in WO 9720358.

The gas diffusion layers preferably have a thickness in the range from 80 μm to 2000 μm, in particular in the range from 100 μm to 1000 μm and particularly preferably in the range from 150 μm to 500 μm.

Furthermore, the gas diffusion layers advantageously have a high porosity. This is preferably in the range from 20% to 80%.

The gas diffusion layers may contain customary additives. These include, inter alia, fluoropolymers such as polytetrafluorethylene (PTFE) and surface-active substances.

According to one particular embodiment, at least one of the gas diffusion layers may be made of a compressible material. Within the context of the present invention, a compressible material is characterized by the property that the gas diffusion layer can be compressed under pressure to half, in particular one third, of its original thickness without losing its integrity.

Gas diffusion layers made of graphite fabric and/or paper which has been made conductive by addition of carbon black generally have this property.

According to one very particularly preferred embodiment of the present invention, at least one gas diffusion layer, preferably both the gas diffusion layer of the cathode and the gas diffusion layer of the anode, comprises glassy carbon. The proportion of glassy carbon, relative to the total weight of the gas diffusion layer, is preferably at least 50.0% by weight, more preferably at least 75.0% by weight, particularly preferably at least 90.0% by weight and in particular at least 95.0% by weight. According to one very particularly preferred variant, the gas diffusion layer consists of glassy carbon.

Glassy carbon is known in specialist circles and denotes a form of carbon with a pronounced structural disarrangement and brittleness, which is preferably obtained by graphitizing and/or carbonizing organic polymers, in particular organic polymer fibres. These starting materials are known to the person skilled in the art and are not subject to any restriction. Suitable organic polymers are mentioned in this description, although this list is not to be regarded as exhaustive.

The catalytically active layer contains a catalytically active substance. Such substances include, inter alia, precious metals, in particular platinum, palladium, rhodium, iridium and/or ruthenium. These substances can also be used in the form of alloys with one another. Furthermore, these substances can also be used in alloys with base metals such as Cr, Zr, Ni, Co and/or Ti for example. In addition, the oxides of the previously mentioned precious metals and/or base metals can also be used. According to known methods, the abovementioned metals are usually used on a support material, usually carbon with a large specific surface area, in the form of nanoparticles.

According to a particular aspect of the present invention, the catalytically active compounds, i.e. the catalysts, are used in the form of particles which preferably have a size in the range from 1 to 1000 nm, in particular 5 to 200 nm and preferably 10 to 100 nm.

According to one particular embodiment of the present invention, the weight ratio of fluoropolymer to catalyst material, comprising at least one precious metal and optionally one or more support materials, is greater than 0.1, wherein this ratio is preferably in the range from 0.2 to 0.6.

According to one particular embodiment of the present invention, the catalyst layer has a thickness in the range from 1 to 1000 μm, in particular from 5 to 500 μm, preferably from 10 to 300 μm. This value represents a mean which can be determined by measuring the layer thickness in cross section from micrographs which can be obtained using a scanning electron microscope (SEM).

According to one particular embodiment of the present invention, the precious metal content of the catalyst layer is from 0.1 to 10.0 mg/cm², preferably from 0.3 to 6.0 mg/cm² and particularly preferably from 0.3 to 3.0 mg/cm². These values can be determined by elemental analysis of a sheet-like sample.

The catalyst layer is usually not self-supporting but rather is usually applied to the gas diffusion layer and/or the membrane. In this case, part of the catalyst layer may for example diffuse into the gas diffusion layer and/or the membrane, as a result of which transition layers are formed. This may also lead to the catalyst layer being perceived as part of the gas diffusion layer.

According to the invention, the surfaces of the polymer electrolyte membrane are in contact with the electrodes in such a way that the first electrode partially or completely, preferably only partially, covers the front side of the polymer electrolyte membrane and the second electrode partially or completely, preferably only partially, covers the rear side of the polymer electrolyte membrane. Here, the front side and the rear side of the polymer electrolyte membrane refer to the side of the polymer electrolyte membrane which respectively faces towards or away from the observer, wherein the direction of observation is from the first electrode (front), preferably the cathode, towards the second electrode (rear), preferably the anode.

For further information concerning polymer electrolyte membranes and electrodes which are suitable according to the invention, reference is made to the specialist literature, in particular to patent applications WO 01/18894 A2, DE 195 09 748, DE 195 09 749, WO 00/26982, WO 92/15121 and DE 197 57 492. The disclosure contained in the aforementioned literature regarding the structure and the production of membrane electrode assemblies and also the electrodes, gas diffusion layers and catalysts to be selected also forms part of the description.

The single fuel cell according to the invention furthermore comprises at least two separator plates. The separator plates here are intended to seal off the gas chambers of the cathode and of the anode from the outside and from one another, optionally in collaboration with further sealing materials. For this purpose, the separator plates are preferably applied to the membrane electrode unit in a sealing manner. The sealing effect can be further improved by pressing together the composite unit composed of separator plates and membrane electrode unit.

Within the context of the present invention, the separator plates in each case have at least one gas channel for reaction gases, which are advantageously arranged on the sides facing towards the electrodes. The gas channels are intended to allow the distribution of the reaction fluids. Preferably, the first separator plate has at least one gas channel for at least one reducing agent, preferably for hydrogen or a reformate, in particular for hydrogen, on the side facing towards the first electrode, and the second separator plate has at least one gas channel for at least one oxidizing agent, in particular for oxygen, on the side facing towards the second electrode.

The specific shape of the respective gas channels may in principle be freely selected. However, it has proven to be particularly useful according to the invention if the gas channels are made in the form of recesses in the separator plate. The ratio of the width of the recesses to the depth of the recesses is in this case preferably in the range from 1:10 to 10:1, preferably in the range from 1:5 to 5:1, in particular in the range from 1:3 to 3:1.

The gas channels preferably have at least one inlet for supplying the respective reaction fluid.

Furthermore, at least one gas channel and preferably all gas channels have at least one outlet for discharging excess reaction fluid and/or one or more reaction products.

According to one particularly preferred embodiment of the present invention, the separator plate has on one side or on both sides a gas channel which comprises an inlet for supplying the respective reaction fluid and an outlet for discharging excess reaction fluid and/or one or more reaction products. The channel in this case advantageously runs from the inlet to the middle of the separator plate and then to the outlet, and preferably has a spiral shape. For the purposes of the present invention, it has proven to be particularly useful to have a channel layout in which the respective reaction fluid is guided from the inlet along a first spiral with a first direction of rotation (right or left) into the middle of the separator plate, then the reaction fluid is guided via a connecting channel into a second spiral which runs parallel to the first spiral, and the reaction fluid is guided along the second spiral to the outlet.

In order to ensure the highest possible output of the single fuel cell, the ratio of the surface area of the gas channels to the total surface area of the separator plate is as large as possible and preferably lies in the range from 1:2 to 1:1, particularly preferably in the range from 3:4 to 99:100, in particular in the range from 4:5 to 95:100. This is advantageously based on the surfaces of the separator plate and of the at least one gas channel which face towards the respective electrode.

Furthermore, the shape of the gas channels is preferably such that the distance traveled by the respective reaction fluid from the inlet in the separator plate to the end of the gas channel in the separator plate is as large as possible. Preferably, the length of this distance is greater than or equal to the circumference of the separator plate and in particular greater than or equal to twice the circumference of the separator plate. The circumference of the separator plate is advantageously determined in the plane of the at least one gas channel. A snake-like or worm-like course of the gas channels has proven to be particularly useful in the context of the present invention.

According to the invention, at least one, preferably at least two, in particular all separator plates comprise glassy carbon. The proportion of glassy carbon, relative to the total weight of the separator plate, is preferably at least 50.0% by weight, more preferably at least 75.0% by weight, particularly preferably at least 90.0% by weight and in particular at least 95.0% by weight. According to one very particularly preferred variant, the separator plate consists of glassy carbon.

The specific resistance of the separator plates is preferably relatively low. Advantageously, at least one, preferably at least two, in particular all separator plates comprising glassy carbon have a specific resistance, measured between two gas diffusion layers at a compacting pressure of 1 MPa and a temperature of 25° C., of at most 20 mΩcm², advantageously at most 15 mΩ cm².

The thickness of the separator plates may in principle be selected at will. It is preferably smaller than that of conventional graphite separator plates and advantageously lies in the range from 0.01 mm to 1.0 mm, particularly preferably in the range from 0.1 mm to 0.5 mm, in particular in the range from 0.2 mm to 0.4 mm.

In a very particularly preferred context of the present invention, at least one separator plate has a respective gas channel for reaction gases on the front and rear side. In this case, seen in cross section, the minimum distance of the at least one gas channel on the front side of the separator plate from the at least one gas channel on the rear side of the separator plate is at least 0.05 mm, advantageously at least 0.1 mm, in order to prevent mixing of the reaction gases.

The separator plates are intended to isolate the cathode gas chamber from the anode gas chamber in the best possible way. Therefore, preferably at least one, more preferably at least two and in particular all separator plates comprising glassy carbon have a helium permeability of at most 10⁻⁸ cm²/s, preferably at most 10⁻⁹ cm²/s, in particular at most 10⁻¹⁰ cm²/s.

The air permeability of at least one, preferably at least two and in particular all separator plates comprising glassy carbon is at most 10⁻⁴ cm²/s, in particular at most 5*10⁻⁵ cm²/s. It is determined with a 2.0 mm standard plate at 25° C. and 1 bar pressure difference according to DIN 51935.

Furthermore, the separator plates have a relatively high mechanical stability. Advantageously, at least one, preferably at least two and in particular all separator plates comprising glassy carbon have a bending strength, measured at 25° C. as a 4-point bending strength with a sample geometry of 3 mm×60 mm, of at least 100 N/mm², preferably at least 150 N/mm², in particular at least 200 N/mm².

The modulus of elasticity of at least one, preferably at least two and in particular all separator plates comprising glassy carbon is advantageously at least 10 kN/mm², preferably at least 20 kN/mm², in particular at least 30 kN/mm².

The compressive strength of at least one, preferably at least two and in particular all separator plates comprising glassy carbon is advantageously at least 10 N/mm², preferably at least 50 N/mm², in particular at least 60 N/mm².

The thermal conductivity of at least one, preferably at least two and in particular all separator plates comprising glassy carbon, perpendicular to the plane of the plate, is advantageously at least 10 W/m K, in particular at least 20 W/m K.

The thermal expansion coefficient of at least one, preferably at least two and in particular all separator plates comprising glassy carbon, in the plane of the plate, is advantageously at most 10/K*10⁻⁶, preferably at most 5/K*10⁻⁶, in particular at most 1/K*10⁻⁶.

The specific electrical resistance of at least one, preferably at least two and in particular all separator plates comprising glassy carbon, in the plane of the plate, is advantageously at most 100 μΩm, in particular at most 50 μΩm.

The specific electrical resistance of at least one, preferably at least two and in particular all separator plates comprising glassy carbon, perpendicular to the plane of the plate and measured with 7.0 N/mm², is advantageously at most 1000 μΩm, preferably at most 600 μΩm, in particular at most 300 μΩm.

The electrical resistance of at least one, preferably at least two and in particular all separator plates comprising glassy carbon, perpendicular to the plane of the plate and measured as the cross-over resistance of a 2.0 mm standard plate with 1.0 N/mm² surface pressure between two gas diffusion layers (typical surface pressure in a fuel cell stack), is advantageously at most 20 mΩcm², preferably at most 15 mΩcm², in particular at most 10 mΩcm².

The production of the membrane electrode unit according to the invention is obvious to the person skilled in the art. In general, the various components of the membrane electrode unit are placed on top of one another and connected to one another by pressure and temperature, with lamination usually being carried out at a temperature in the range from 10 to 300° C., in particular 20° C. to 200° C., and at a pressure in the range from 1 to 1000 bar, in particular from 3 to 300 bar.

According to a first preferred embodiment of the invention, the production of the single fuel cell comprises assembling at least two electrochemically active electrodes, at least one polymer electrolyte membrane and at least two separator plates in the desired order, wherein at least one separator plate is obtained by
i) shaping at least one blank for the at least one separator plate from a starting polymer,
ii) providing the blank from step i) with at least one gas channel for reaction gases, and
iii) pyrolysing the machined blank from step ii) at temperatures below 2000° C., in particular at temperatures >500° C. to 2000° C.

As the starting polymer, it is possible in principle to use any known polymer or even a blend of two or more polymers. Preferably, use is made of an organic polymer which advantageously comprises C, H and/or O and/or N (and/or S and/or P). The C component of the polymer, relative to its total weight, preferably lies in the range from 60.0% by weight to 95.0% by weight, in particular in the range from 70.0% by weight to 90.0% by weight. The H component of the polymer, relative to its total weight, preferably lies in the range from 1.0% by weight to 10.0% by weight. The O component of the polymer, relative to its total weight, preferably lies in the range from 0.0% by weight to 30.0% by weight. The N component of the polymer, relative to its total weight, preferably lies in the range from 0.0% by weight to 30.0% by weight. The P or S component of the polymer, relative to its total weight, preferably lies in the range from 0.0% by weight to 30.0% by weight.

Most suitable are highly crosslinkable aromatic polymers, in particular polyphenylenes, polyimides, polyazoles, polybenzimidazoles, polybenzoxazoles, polyoxadiazoles, polypyrazoles, polytetraazopyrenes, polytriazoles, polybenzothiazoles, polyphosphazene, aromatic epoxies, phenol resins and furan resins, the best results being achieved with polyazoles, in particular with polybenzimidazoles. Polyazoles and polybenzimidazoles which are very particularly suitable in this connection are described above as a possible membrane material.

The shaping may take place in a manner known per se. Shaping methods which are particularly suitable for the purposes of the present invention include injection casting, centrifugal casting, casting, injection pressing and hot pressing. The shaping may also take place after the production of a polymer film by punching out or cutting with blades or lasers. In one particularly preferred embodiment of the present invention, the production of the single fuel cells takes place by shaping a blank made from at least one crosslinkable aromatic polymer in step i) and crosslinking the latter.

The crosslinking may in this case take place in a manner known per se, with the following proving to be particularly useful in the present case:
chemical crosslinking with a crosslinker, preferably with a vinyl crosslinker, in particular with divinylbenzene and/or divinylsulphone, with an epoxy crosslinker, in particular with bisphenol-A diglycidyl ether, and/or with a diisocyanate, very particularly H2SO4 or H3PO4, and subsequent heat treatment
a crosslinking induced by UV light or IR light
a crosslinking by b- or g-radiation and
a crosslinking by means of plasma treatment.

According to one particularly preferred variant, the crosslinking takes place chemically while at the same time irradiating with UV light or IR light.

After shaping, the blank is provided with at least one gas channel. This may be carried out in a manner known per se, by advantageously allowing the blank from step i) to cure and providing it with at least one recess preferably by means of milling and/or laser ablation.

The pyrolysis of the machined blank preferably takes place by gradually heating the machined blank. In this case, it is possible to raise the temperature either continuously or in stages. Intermediate cooling of the machined blank is also conceivable in principle.

The rate of heating and the temperature profile are advantageously selected in a manner tailored to the respective type of resin.

The pyrolysis is advantageously carried out essentially between 200° C. and 600° C. The loss of mass of the machined blank, relative to its starting weight, is advantageously 1.0% to 40.0% and in particular 5.0% by weight to 30.0% by weight.

One significant advantage of the method according to the invention is that the blank essentially retains its shape during the pyrolysis. The linear shrinkage of the blank is less than 25%, with the body expanding again by approximately 5% during a subsequent treatment at high temperature. By means of the method according to the invention, therefore, it is possible in a relatively simple manner to define the shape of the resulting separator plate, in particular the layout of the gas channels, by corresponding machining of the blank. There is no need for subsequent machining of the relatively brittle glassy carbon.

According to one very particularly preferred variant of the present invention, the method according to the invention also comprises the step of producing at least one, preferably at least two, gas diffusion layers by shaping at least one blank for the at least one gas diffusion layer from a starting polymer,

providing the blank from step ii) with at least one gas channel for reaction gases, and
pyrolysing the machined blank from step ii) at temperatures below 2000° C., in particular at temperatures >500° C. to 2000° C.

Preferred embodiments of this variant for producing the gas diffusion layers correspond to the above-described embodiments for the production of the separator plates, with the exception that the gas channels in the gas diffusion layers preferably run perpendicularly, i.e. from top to bottom, through the gas diffusion layers and in the case of the separator plates preferably run on the front side or the rear side of the separator plates, i.e. parallel to the main surfaces of the separator plates (front side and rear side).

Within the context of the present invention, it has proven to be very particularly useful if the machined blank(s) for the separator plate(s) and the machined blank(s) for the gas diffusion layer(s) are joined to form a single blank prior to pyrolysis, and then this resulting blank is pyrolysed.

Since the output of a single fuel cell is often too low for many applications, within the context of the present invention a plurality of single fuel cells are combined to form a fuel cell (fuel cell stack). The present invention therefore relates, according to one aspect, to a fuel cell which comprises at least two anodes, at least two cathodes, at least two polymer electrolyte membranes and at least one separator plate in the following order:

first anode/first polymer electrolyte membrane/first cathode/separator plate/second anode/second polymer electrolyte membrane/second cathode,
wherein the fuel cell is characterized in that
the at least one separator plate has in each case at least one gas channel for reaction gases on the side facing towards the first cathode and on the side facing towards the second anode, and
the at least one separator plate comprises glassy carbon.

In this connection, the at least one separator plate has at least one gas channel for at least one oxidizing agent on the side facing towards the first cathode and has at least one gas channel for at least one reducing agent on the side facing towards the second anode.

In a particularly surprising manner, it has been found that single fuel cells according to the invention can be stored or shipped without any problem due to their dimensional stability at fluctuating ambient temperatures and relative humidity. Even after relatively long periods of storage or after being shipped to locations with very different climatic conditions, the dimensions of the single fuel cells are suitable for incorporation in fuel cell stacks. The single fuel cell thus no longer needs to be conditioned on site for external installation, which simplifies production of the fuel cell and saves time and money.

One advantage of preferred single fuel cells is that they allow operation of the fuel cell at temperatures above 120° C. This applies in respect of gaseous and liquid fuels, such as hydrogen-containing gases for example, which are produced for example from hydrocarbons in an upstream reformation step. As the oxidant, it is possible to use oxygen or air for example.

A further advantage of preferred single fuel cells is that they have a high tolerance to carbon monoxide during operation above 120° C. even with pure platinum catalysts, i.e. without any further alloy component. At temperatures of 160° C., for example more than 1% CO can be contained in the combustion gas without this leading to a marked reduction in performance of the fuel cell.

Preferred single fuel cells can be operated in fuel cells without having to wet the combustion gases and oxidants, despite the possible high operating temperatures. The fuel cell nevertheless operates in a stable manner, and the membrane does not lose its conductivity. This simplifies the entire fuel cell system and brings additional cost savings since the water circuit is simplified. This also results in an improvement in behaviour at temperatures below 0° C. of the fuel cell system.

Preferred single fuel cells surprisingly make it possible for the fuel cell to be cooled to room temperature and below without any problem and then to be operated again without any loss in performance. By contrast, conventional fuel cells based on phosphoric acid sometimes have to be kept at a temperature above 40° C. even after switch-off of the fuel cell system, in order to prevent irreversible damage.

Furthermore, the preferred single fuel cells of the present invention have a very high long-term stability. It has been found that a fuel cell according to the invention can be operated continuously with dry reaction gases at temperatures of more than 120° C. for long periods of time, e.g. more than 5000 hours, without any noticeable degradation in performance. The power densities which can be achieved in this case are very high even after such a long time.

Even after a long time, for example more than 5000 hours, the fuel cells according to the invention still have a high resting voltage which after this time is preferably at least 900 mV. In order to measure the resting voltage, a fuel cell is operated without current with a hydrogen flow on the anode and an air flow on the cathode. The measurement is carried out by switching the fuel cell from a current of 0.2 A/cm² to the powerless state and then recording the resting voltage for 5 minutes. The value after 5 minutes is the corresponding rest potential. The measured values of the resting voltage are valid for a temperature of 160° C. Furthermore, after this time, the fuel cell preferably exhibits a low gas cross-over. In order to measure the cross-over, the anode side of the fuel cell is operated with hydrogen (5 l/h) and the cathode is operated with nitrogen (5 l/h). The anode serves as the reference electrode and counterelectrode. The cathode serves as the working electrode. The cathode is placed at a potential of 0.5 V and the hydrogen diffusing through the membrane is oxidized at the cathode in a manner limited by mass transport. The resulting current is a measure of the hydrogen permeation rate. The current is <3 mA/cm², preferably <2 mA/cm², particularly preferably <1 mA/cm² in a 50 cm² cell. The measured values of the H₂ cross-over are valid for a temperature of 160° C.

The single fuel cells according to the invention have a relatively low weight and a relatively small volume and are suitable in particular for weight-critical and/or volume-critical applications.

Furthermore, the single fuel cells according to the invention are characterized by an improved heat resistance and corrosion resistance and a relatively low gas permeability, particularly at high temperatures. According to the invention, a reduction in mechanical stability and in structural integrity, particularly at high temperatures, is as far as possible avoided.

Furthermore, the single fuel cells according to the invention can be produced in a simple and cost-effective manner.

For further information concerning membrane electrode assemblies, reference is made to the specialist literature, in particular to patents U.S. Pat. No. 4,191,618, U.S. Pat. No. 4,212,714 and U.S. Pat. No. 4,333,805. The disclosure contained in the aforementioned literature [U.S. Pat. No. 4,191,618, U.S. Pat. No. 4,212,714 and U.S. Pat. No. 4,333,805] regarding the structure and the production of membrane electrode assemblies and also the electrodes, gas diffusion layers and catalysts to be selected also forms part of the description.

1.-22. (canceled)

23. A single fuel cell comprising
a) at least two electrochemically active electrodes which are separated by a polymer electrolyte membrane, and
b) at least two separator plates which in each case have at least one gas channel for reaction gases,
wherein at least one separator plate comprises glassy carbon.

24. The single fuel cell according to claim 23, wherein said at least one separator plate contains at least 50.0% by weight of glassy carbon, relative to its total weight.

25. The single fuel cell according to claim 23, wherein said at least one separator plate comprising glassy carbon has a specific resistance, measured between two gas diffusion layers and at a compacting pressure of 1 MPa and a temperature of 25° C., of at most 20 mΩcm².

26. The single fuel cell according to claim 23, wherein the at least one separator plate comprising glassy carbon has a thickness in the range from 0.01 mm to 1.0 mm.

27. The single fuel cell according to claim 23, wherein said at least one separator plate comprising glassy carbon has a helium permeability of at most 10⁻⁸ cm²/s.

28. The single fuel cell according to claim 23, wherein said first separator plate has at least one gas channel for at least one reducing agent on the side facing towards the first electrode, and the second separator plate has at least one gas channel for at least one oxidizing agent on the side facing towards the second electrode.

29. The single fuel cell according to claim 23, wherein the polymer electrolyte membrane comprises polyazoles.

30. The single fuel cell according to claim 23, wherein the polymer electrolyte membrane is doped with an acid.

31. The single fuel cell according to claim 30, wherein the polymer electrolyte membrane is doped with phosphoric acid.

32. The single fuel cell according to claim 31, wherein the concentration of the phosphoric acid is at least 50% by weight.

33. The single fuel cell according to claim 23, wherein the polymer electrolyte membrane is obtainable by a method comprising the following steps
A) mixing one or more aromatic tetraamino compounds with one or more aromatic carboxylic acids or esters thereof which contain at least two acid groups per carboxylic acid monomer, or mixing one or more aromatic and/or heteroaromatic diaminocarboxylic acids in polyphosphoric acid to form a solution and/or dispersion,
B) applying a layer using the mixture according to step A) to a support or to an electrode,
C) heating the sheet-like structure/layer obtainable according to step B) under inert gas to temperatures of up to 350° C. to form the polyazole polymer,
D) treating the membrane formed in step C) until it is self-supporting.

34. The single fuel cell according to claim 33, wherein the heating is up to 280° C.

35. The single fuel cell according to claim 31, wherein the degree of doping is between 3 and 50.

36. The single fuel cell according to claim 23, wherein the polymer electrolyte membrane comprises polymers obtainable by polymerization of monomers containing phosphonic acid groups and/or monomers containing sulphonic acid groups.

37. The single fuel cell according to claim 23, wherein at least one of the electrodes is made of a compressible material.

38. The single fuel cell according to claim 23, wherein at least one of the electrodes comprises glassy carbon.

39. A method for producing a single fuel cell, in which two electrochemically active electrodes, a polymer electrolyte membrane and two separator plates are assembled in the desired order, wherein at least one separator plate is obtained by
i) shaping at least one blank for the at least one separator plate from a starting polymer,
ii) providing the blank from step i) with at least one gas channel for reaction gases, and
iii) pyrolysing the machined blank from step ii) at temperatures below 2000° C.

40. The method according to claim 39, wherein, in step i), a blank is shaped from at least one crosslinkable aromatic polymer and the latter is crosslinked.

41. The method according to claim 40, wherein the crosslinkable polymer comprises at least one polyphenylene, polyimide, aromatic epoxy, phenol resin and/or furan resin.

42. The method according to claim 39, wherein the pyrolysis is carried out until a loss in mass of 1.0% to 40.0% is obtained, relative to the starting weight of the machined blank.

43. The method according to claim 39, wherein at least one gas diffusion layer is produced by
a) shaping at least one blank for the at least one gas diffusion layer from a starting polymer,
b) providing the blank from step a) with at least one gas channel for reaction gases, and
c) pyrolysing the machined blank from step b) at temperatures below 2000° C.

44. The method according to claim 43, wherein pyrolysing is conducted at temperatures >500° C. to 2000° C.

45. A fuel cell, comprising at least two anodes, at least two cathodes, at least two polymer electrolyte membranes and at least one separator plate in the following order:
first anode/first polymer electrolyte membrane/first cathode/separator plate/second anode/second polymer electrolyte membrane/second cathode,
wherein
the at least one separator plate has in each case at least one gas channel for reaction gases on the side facing towards the first cathode and on the side facing towards the second anode, and
the at least one separator plate comprises glassy carbon.

46. The fuel cell according to claim 45, wherein the at least one separator plate has at least one gas channel for at least one oxidizing agent on the side facing towards the first cathode and has at least one gas channel for at least one reducing agent on the side facing towards the second anode.
